(19) United States
(12) Patent Application Publication
(10) Pub. No.: US 2026/0152832 A1
(43) Pub. Date: Jun. 4, 2026

(54) TOOL STEEL MATERIALS FOR ADDITIVE MANUFACTURING

(71) Applicants: Massachusetts Institute of Technology, Cambridge, MA (US); Universität Paderborn, Paderborn (DE)

(72) Inventors: Gregory Olson, Revere, MA (US); Florian Konrad Hengsbach, Paderborn (DE); Krista Biggs, Somerville, MA (US); Mirko Schaper, Salzkotten (DE)

(73) Assignees: Massachusetts Institute of Technology, Cambridge, MA (US); Universität Paderborn, Paderborn (DE)

(21) Appl. No.: 18/877,754

(22) PCT Filed: Jun. 29, 2023
(86) PCT No.: PCT/US2023/026573

§ 371 Date: Dec. 20, 2024

Related U.S. Application Data
(60) Provisional application No. 63/357,610, filed on Jun. 30, 2022.

(51) Int. Cl. C22C 38/28; B22F 10/28; B33Y 10/00; B33Y 70/00; C22C 38/00; C22C 38/22; C22C 38/24

(52) U.S. Cl. CPC C22C 38/28; B33Y 70/00; C22C 38/001; C22C 38/002; C22C 38/005; C22C 38/22; C22C 38/24; B22F 10/28; B22F 2301/35; B33Y 10/00

(57) ABSTRACT

This steel compositions for use in additive manufacturing are disclosed. In some embodiments, a metal alloy includes a majority iron in addition to carbon, molybdenum, vanadium, and tungsten. Overall, there may be a ratio of a combined atomic percentage of molybdenum, vanadium, and tungsten relative to carbon that is between or equal to 2:1 and 5:1. Other components such as grain refiners and/or oxidation resistant materials may also be included in such an alloy.

### CROSS-REFERENCE TO RELATED APPLICATIONS

This application claims the benefit under 35 U.S.C. § 119(e) of U.S. provisional application Ser. No. 63/357,610, filed Jun. 30, 2022, the disclosure of which is incorporated by reference in its entirety.

### FIELD

Disclosed embodiments are related to tool steel materials for additive manufacturing and related methods.

### BACKGROUND

Various additive manufacturing techniques can be used in a number of different applications for either replacing existing manufacturing techniques and/or for enabling the production of part geometries that cannot be manufactured with other type of manufacturing processes. There are a number of different types of additive manufacturing techniques including laser powder bed fusion where components may be manufactured by selectively fusing portions of sequentially deposited layers of a fusible powder material (e.g., a metal powder) to form the desired component geometries in a layer based formation process. Prior attempts to reduce cracking in additive manufacturing of certain metal alloys have focused on improving thermal conductivity, but have been unsuccessful in reducing cracking of the alloys during a printing process.

### SUMMARY

In some embodiments, a metal alloy includes: iron; carbon; molybdenum; vanadium; and tungsten. A ratio of a combined atomic percentage (at %) of molybdenum, vanadium, and tungsten relative to carbon within the alloy is between or equal to 2:1 and 5:1.

In some embodiments, an additive manufacturing method includes: fusing one or more portions of a metal powder deposited during the additive manufacturing method to form a component. The metal powder comprises particles comprising a metal alloy, where the metal alloy comprises: iron; carbon; molybdenum; vanadium; and tungsten. A ratio of a combined atomic percentage (at %) of molybdenum, vanadium, and tungsten relative to carbon within the alloy is between or equal to 2:1 and 5:1.

In some embodiments, a metal alloy is provided. According to some embodiments, the metal alloy comprises: iron; carbon; molybdenum; vanadium; chromium; and tungsten, and wherein a ratio of a combined atomic percentage (at %) of molybdenum, vanadium, and tungsten relative to carbon within the alloy is between or equal to 2:1 and 5:1, and wherein an atomic percentage of the chromium is between or equal to 7 at % and 10 at %.

In some embodiments a metal alloy is provided. According to some embodiments, the additive manufacturing method comprises: iron; carbon; chromium; and a transition metal selected from the group consisting of molybdenum, vanadium, and tungsten; wherein a ratio of a combined atomic percentage (at %) of molybdenum, vanadium, and tungsten relative to carbon within the alloy is between or equal to 2:1 and 5:1, wherein the metal alloy comprises one or more phases, the one or more phases including a first, δ-ferrite phase, and wherein the first, δ-ferrite phase is present in the metal alloy in a phase fraction of at least 0.85.

According to some embodiments, an additive manufacturing method is provided. According to some embodiments, the additive manufacturing method comprises: fusing one or more portions of a metal powder deposited during the additive manufacturing method to form a component, wherein the metal powder comprises particles comprising a metal alloy, wherein the metal alloy comprises: iron; carbon; molybdenum; vanadium; chromium; and tungsten, and wherein a ratio of a combined atomic percentage (at %) of molybdenum, vanadium, and tungsten relative to carbon within the alloy is between or equal to 2:1 and 5:1, and wherein an atomic percentage of the chromium is between or equal to 7 at % and 10 at %.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 presents a non-limiting schematic representation of a method of additively manufacturing a metal alloy, according to some embodiments.

FIG. 2 is a calculated phase diagram for a variety of temperatures and compounds according to some embodiments.

FIG. 3 is a calculated phase diagram for a variety of mole fractions and compounds according to some embodiments.

FIG. 4A is a chart showing the equilibrium phases of steel at various concentrations of Molybdenum and Chromium according to some embodiments.

FIG. 4B is a chart showing δ-ferrite solidification at various concentrations of Molybdenum and Chromium according to some embodiments.

FIG. 5 is a calculated phase diagram for a variety of temperatures and compounds according to some embodiments.

FIG. 6 is a calculated phase diagram for a variety of mole fractions and compounds according to some embodiments.

FIG. 7 is a calculated phase diagram for a variety of temperatures and compounds according to some embodiments.

FIG. 8 is a calculated phase diagram for a variety of mole fractions and compounds according to some embodiments.

FIG. 9 is a chart correlating tempering temperature to hardness according to some embodiments.

FIG. 10 is a chart correlating hardness to energy absorption according to some embodiments.

### DETAILED DESCRIPTION

The inventors have recognized that novel steels and alloys are needed for use in establishing beam-based additive manufacturing (AM) techniques in industrial production. However, many currently available materials, such as tool steels, are not appropriate for use in additive manufacturing processes. Specifically, when additively processed via laser- or electron-beam, numerous metallic materials face barriers based on undesired solid-state or hot cracking. Many overlapping effects exist that result in solidification cracking of laser powder bed fusion (LPBF) processed steels. Accordingly, the inventors have recognized a need for appropriate tool steel compositions capable of being used in additive manufacturing processes.

In view of the above, the Inventors have recognized the benefits associated with tool steel compositions configured to avoid cracking during use in an additive manufacturing process. Avoiding cracking may greatly improve the applications of tool steel within additive manufacturing technology. In an industry where strength and durability are concerns, resistance to heat, and/or corrosion resistance may be desirable in addition to the reduction of cracking during formation. Various embodiments of possible tool steel compositions providing either these and/or other desirable properties are elaborated on below.

In some aspects, the disclosure is directed towards tool steel compositions that kinetically stabilize δ-ferrite formation in as-printed steel. The δ-ferrite phase is a steel phase comprising a BCC lattice of Fe atoms with interstitial carbon. The δ-ferrite phase forms for some steels equilibrated at high temperatures (e.g., cooled from liquid form). However, as temperature is reduced, the δ-ferrite phase becomes thermodynamically unstable and other steel phases tend to dominate the steel microstructure. For example, as the steel cools, it first forms an austenite phase comprising an FCC lattice of Fe atoms. As the temperature is reduced further, the equilibrium shifts to favor formation of α-ferrite, which comprises a BCC lattice of Fe atoms, and other phases such as cementite. Despite the similar lattice arrangement, δ-ferrite and α-ferrite have different thermodynamic and mechanical properties that can impact the performance of each phase. For example, impurity atoms may have a higher solubility in the δ-ferrite lattice than in the α-ferrite, which can impact the strength and toughness of the steel by changing the energy associated with dislocation glide.

The Inventors have recognized that significant improvements to the additive manufacturing of tool steel could be achieved through the use of alloys that are crack-resistant and retain good mechanical properties when printed. In certain aspects, steel alloys that retain the δ-ferrite phase at temperatures below the equilibrium temperature of δ-ferrite and have been shown to have significantly improved crack resistance are provided herein. Therefore, inventors have recognized the benefit associated with alloys including increased proportions of δ-ferrite which may improve the resistance of the alloy to cracking during formation in an additive manufacturing process. Further, the inventors have recognized that the δ-ferrite phase can be kinetically stabilized at lower temperatures by introducing one or more δ-ferrite stabilizers to the composition. For example, Cr, V, W, and Mo may act as δ-ferrite stabilizers. Without wishing to be bound by any particular theory, carbide-strengthened steel can be difficult to stabilize using δ-ferrite stabilizers because δ-ferrite stabilizers should ideally be soluble at the austenite solutionizing temperature but many δ-ferrite stabilizers are insoluble in austenite at the austenite solutionizing temperature, when they can segregate into carbide phases. In certain embodiments, Cr may be a particularly useful additive for promoting δ-ferrite formation in tool steels, owing to its comparatively high solubility in the austenite phase. In some embodiments, for example, steels with relatively high concentrations of Cr can be used to form steel alloys including high concentrations of kinetically trapped δ-ferrites. Accordingly, the present disclosure is directed, according to some embodiments, towards a tool steel comprising relatively high concentrations of chromium.

The initial solidification of a steel during an additive manufacturing process prior to post formation processing (e.g., post process annealing) may be associated with rapid cooling of the tool steel, e.g., during an additive manufacturing process such as laser powder bed fusion (LPBF). In some embodiments, the tool steel is solidified using a cooling rate of greater than or equal to 100° C./s, 200° C./s, 300° C./s, 500° C./s, 1,000° C./s, 5,000° C./s, 10,000° C./s, 50,000° C./s, 100,000° C./s, 500,000° C./s, 1,000,000° C./s, or greater. In some embodiments, the tool steel is solidified using a cooling rate of less than or equal to 10,000,000° C./s, 5,000,000° C./s, 1,000,000° C./s, 500,000° C./s, 100,000° C./s, 50,000° C./s, 10,000° C./s, 5,000° C./s, 1,000° C./s, 500° C./s, or less. Combinations of these ranges are possible. For example, in some embodiments, the tool steel is solidified using a cooling rate of greater than or equal to 100° C./s and less than or equal to 5,000° C./s. Other ranges, both higher and lower than those described above, are also possible, as the disclosure is not so limited.

In some embodiments, a tool steel as disclosed herein may use various metallurgical mechanisms to exploit the process advantages of rapid solidification processes such as gas-atomization and laser powder bed fusion (LPBF). In some embodiments, carbide precipitation modification may be used for crack-resistant tool steel processing via LPBF and/or another appropriate additive manufacturing processes. The driving force for carbide formers may be chosen to obtain a large volume fraction of nano-scale transition metal carbide (M₂C where M is a transition metal) via precipitation during a heat treatment procedure (e.g., during a heat treatment procedure performed subsequent to an additive manufacturing process). In some embodiments, grain refinement may also be provided using a grain refiner included in a tool steel composition. Grain refiners such as titanium nitride TiN, titan carbonitride Ti(C,N), titan carbide TiC, titan diboride TiB₂, zirconium nitride ZrN, titanium(II) oxide TiO, combinations of the above, and/or any of a variety of other appropriate grain refiners may be included in the alloy. The disclosed tool steels may be particularly designed for the processing conditions experienced during additive manufacturing.

In some embodiments, it may be desirable to provoke heterogeneous nucleation within an alloy when the material is melted and resolidified during an additive manufacturing process. Accordingly, in some embodiments, an alloy, which may be provided in the form of a metal powder, may include a nucleation catalyst, such as nucleation catalyst particles, distributed in the alloy. The catalyst particles may have average maximum transverse dimensions (e.g., average maximum diameter) between or equal to 20 nm and 1000 nm. Ranges interior to this range are also possible. For example, in some embodiments, the catalyst particles dispersed within the alloy may have an average maximum transverse dimension of greater than or equal to 20 nm, greater than or equal to 50 nm, greater than or equal to 100 nm, greater than or equal to 250 nm, greater than or equal to 500 nm, greater than or equal to 750 nm, or greater. In some embodiments, the catalyst particles may have an average maximum transverse dimension of less than or equal to 1000 nm, less than or equal to 750 nm, less than or equal to 500 nm, less than or equal to 250 nm, less than or equal to 100 nm, less than or equal to 50 nm, or less. Combinations of these ranges are possible. For example, in some embodiments, the catalyst particles may have an average maximum transverse dimension of greater than or equal to 20 nm and less than or equal to 1000 nm. Other ranges, both higher and lower than those described above, are also possible, as the disclosure is not so limited.

Possible catalysts that may be included in an alloy may include, but are not limited to, TiN, TiO, TiB₂, ZrN, and/or any other appropriate material. Depending on the embodiment, catalyst particles may be included in an alloy by through inclusion in a crucible as pre-alloyed catalyst particles, integrated with a high-pressure dispersing gas, precipitated during gas-atomization and/or any other appropriate method. Depending on the embodiment, the catalyst particles may be included in a weight percent that is between or equal to 0.01 atomic percent (at %) and 2.0 at %, though other ranges both greater than and less than those noted above are contemplated.

The disclosed materials and method may include the formation and use of a metal powder comprising a desired tool steel composition that may be resistant to cracking during additive manufacturing processes. The tool steels disclosed herein may include a metal alloy comprising iron, carbon, molybdenum, vanadium, and tungsten. These elements may be provided in appropriate proportions such that the proportions of carbon, molybdenum, vanadium, and tungsten are at or above the stoichiometric ratio for forming transition metal carbides with the formula M₂C where M is one of the above noted transition metals. For example, a ratio of a combined atomic percentage (at %) of molybdenum, vanadium, and tungsten relative to carbon within the overall alloy composition may be greater than or equal to 2:1. Further, in some embodiments, the ratio may be between or equal to 2:1 and 5:1. Ranges interior and exterior to this range are also possible. For example, in some embodiments, a ratio of a combined atomic percentage (at %) of molybdenum, vanadium, and tungsten relative to carbon within the overall alloy composition is greater than or equal to 1:1, greater than or equal to 1.5:1, greater than or equal to 2:1, greater than or equal to 2.5:1, greater than or equal to 3:1, greater than or equal to 3.5:1, greater than or equal to 4:1, greater than or equal to 4.5:1, or greater. In some embodiments, a ratio of a combined atomic percentage (at %) of molybdenum, vanadium, and tungsten relative to carbon within the overall alloy composition is less than or equal to 5:1, less than or equal to 4.5:1, less than or equal to 4:1, less than or equal to 3.5:1, less than or equal to 3:1, less than or equal to 2.5:1, or less. Combinations of these ranges are possible. For example, in some embodiments, the ratio is greater than or equal to 1:1 and less than or equal to 5:1. Other ranges, both higher and lower than those described above, are also possible, as the disclosure is not so limited. Without wishing to be bound by theory, such a composition may favor the formation of transition metal carbides with a size scale and distribution that may help prevent cracking of parts formed from these materials.

In some embodiments, a tool steel as disclosed herein, including the above embodiment, may include various elements with the following atomic ranges. Molybdenum may be present in a concentration that is between or equal to 2 atomic percent (at %) and 4 at %. Ranges interior to this range are also possible. For example, in some embodiments, molybdenum is present in a concentration that is greater than or equal to 2 at %, greater than or equal to 2.5 at %, greater than or equal to 3 at %, greater than or equal to 3.5 at %, or greater. In some embodiments, the molybdenum is present in a concentration that is less than or equal to 4 at %, less than or equal to 3.5 at %, less than or equal to 3 at %, less than or equal to 2.5 at %, or less. Combinations of these ranges are possible. For example, in some embodiments, molybdenum is present in a concentration that is greater than or equal to 2 at % and less than or equal to 4 at %. Other ranges, both higher and lower than those described above, are also possible, as the disclosure is not so limited.

Vanadium may be present in a concentration that is between or equal to 0.5 at % and 2 at %. Ranges interior to this range are also possible. For example, in some embodiments, vanadium is present in a concentration that is greater than or equal to 0.5 at %, greater than or equal to 0.8 at %, greater than or equal to 1.0 at %, greater than or equal to 1.2 at %, greater than or equal to 1.5 at %, greater than or equal to 1.8 at %, or greater. In some embodiments, the vanadium is present in a concentration that is less than or equal to 2 at %, less than or equal to 1.8 at %, less than or equal to 1.5 at %, less than or equal to 1.2 at %, less than or equal to 1 at %, less than or equal to 0.8 at %, or less. Combinations of these ranges are possible. For example, in some embodiments, vanadium is present in a concentration that is greater than or equal to 0.5 at % and less than or equal to 2 at %. Other ranges, both higher and lower than those described above, are also possible, as the disclosure is not so limited.

Tungsten may be present in the disclosed alloys in a concentration that is between or equal to 0.1 at % and 0.3 at %. Ranges interior to this range are also possible. For example, in some embodiments, tungsten is present in a concentration that is greater than or equal to 0.1 at %, greater than or equal to 0.15 at %, greater than or equal to 0.2 at %, greater than or equal to 0.25 at %, or greater. In some embodiments, the tungsten is present in a concentration that is less than or equal to 0.3 at %, less than or equal to 0.25 at %, less than or equal to 0.2 at %, less than or equal to 0.15 at %, or less. Combinations of these ranges are possible. For example, in some embodiments, tungsten is present in a concentration that is greater than or equal to 0.1 at % and less than or equal to 0.3 at %. Other ranges, both higher and lower than those described above, are also possible, as the disclosure is not so limited.

Carbon may be present in in the disclosed alloys in a concentration that is between or equal to 1.15 at % and 2.5 at %. Ranges interior and exterior to this range are also possible. For example, in some embodiments, carbon is present in a concentration that is greater than or equal to 0.5 at %, greater than or equal to 0.6 at %, greater than or equal to 0.7 at %, greater than or equal to 0.8 at %, greater than or equal to 1 at %, greater than or equal to 1.15 at %, greater than or equal to 1.2 at %, greater than or equal to 1.5 at %, greater than or equal to 1.8 at %, greater than or equal to 2 at %, greater than or equal to 2.2 at %, or greater. In some embodiments, carbon is present in a concentration that is less than or equal to 2.5 at %, less than or equal to 2.2 at %, less than or equal to 2 at %, less than or equal to 1.8 at %, less than or equal to 1.5 at %, less than or equal to 1.2 at %, less than or equal to 1.15 at %, less than or equal to 1 at %, less than or equal to 0.8 at %, less than or equal to 0.7 at %, less than or equal to 0.6 at %, or less. Combinations of these ranges are possible. For example, in some embodiments, carbon is present in a concentration that is greater than or equal to 0.5 at % and less than or equal to 2.5 at %. Other ranges, both higher and lower than those described above, are also possible, as the disclosure is not so limited.

The rest of the alloy may comprise iron with one or more other potential desired additives. While specific ranges of elemental compositions are provided above, it should be understood that other compositional ranges both greater than and less than those noted above, as well as the inclusion of other materials, are also contemplated as the disclosure is not so limited, though the disclosed ranges and ratios have been identified to be associated with reduced cracking of the alloys during formation in an additive manufacturing process.

As noted above, in some embodiments, it may be desirable for a tool steel alloy as disclosed herein to exhibit corrosion and/or oxidation resistance. A metal alloy, such as those described above, may further comprise chromium, which may be particularly advantageous for tool steels that exhibit corrosion and/or oxidation resistance. As discussed above, chromium can also help to kinetically stabilize δ-ferrite, resulting in a δ-ferrite rich microstructure.

An atomic percentage of the chromium included in the various embodiments of an alloy disclosed herein may be between or equal to 7 at % and 10 at %. Ranges interior to this range are also possible. For example, in some embodiments, chromium is present in a concentration that is greater than or equal to 7 at %, greater than or equal to 7.5 at %, greater than or equal to 8 at %, greater than or equal to 8.5 at %, greater than or equal to 9 at %, greater than or equal to 9.5 at %, or greater. In some embodiments, chromium is present in a concentration that is less than or equal to 10 at %, less than or equal to 9.5 at %, less than or equal to 9 at %, less than or equal to 8.5 at %, less than or equal to 8 at %, less than or equal to 7.5 at %, or less. Combinations of these ranges are possible. For example, in some embodiments, chromium is present in a concentration that is greater than or equal to 7 at % and less than or equal to 10 at %. While specific ranges of chromium concentration in an alloy are provided above, it should be understood that other ranges both greater than and less than those noted above are also contemplated as the disclosure is not so limited.

As discussed above, the addition of δ-ferrite stabilizers such as chromium, vanadium, tungsten, and molybdenum may be used to stabilize the δ-ferrite phase, resulting in manufacturing of a steel alloy with a high phase fraction of δ-ferrite after initial solidification of the alloy during an additive manufacturing process and prior to post processing of the alloy (e.g., annealing and tempering). In some embodiments, the tool steel alloy has a microstructure comprising δ-ferrite in a molar phase fraction of greater than or equal to 0.5, greater than or equal to 0.6, greater than or equal to 0.7, greater than or equal to 0.8, greater than or equal to 0.85, greater than or equal to 0.9, greater than or equal to 0.92, greater than or equal to 0.95, or more. In some embodiments, the tool steel alloy has a microstructure comprising δ-ferrite in a molar phase fraction of less than or equal to 1, less than or equal to 0.95, less than or equal to 0.92, less than or equal to 0.9, less than or equal to 0.85, less than or equal to 0.8, less than or equal to 0.7, less than or equal to 0.6, or less. Combinations of these ranges are possible. For example, in some embodiments, the tool steel alloy has a microstructure comprising δ-ferrite in a molar phase fraction of greater than or equal to 0.5 and less than or equal to 1. In some embodiments, the δ-ferrite phase is present in the metal alloy in a phase fraction of at least 0.5. According to some embodiments, the δ-ferrite phase is present in the metal alloy in a phase fraction of at least 0.92. Other ranges, both higher and lower than those described above, are also possible, as the disclosure is not so limited. The above-mentioned phase fractions may be found within a tool steel alloy before or after tempering of the tool steel alloy, depending on the embodiment.

To provide a desired combination of alloy material properties, a tool steel alloy as disclosed herein may exhibit a desired proportion of ferritic to austenitic phase after heat treatment. For example, a heat treated metal alloy may include a proportion of an austenitic phase that is less than or equal to 30% of the metal alloy. Ranges interior to this range are also possible. For example, in some embodiments, the heat treated metal alloy includes a molar proportion of the austenitic phase that is less than or equal to 30%, less than or equal to 25%, less than or equal to 20%, less than or equal to 15%, less than or equal to 10%, less than or equal to 5%, less than or equal to 1%, or less. In some embodiments, the heat treated metal alloy includes a molar proportion of the austenitic phase that is greater than or equal to 0%, greater than or equal to 1%, greater than or equal to 5%, greater than or equal to 10%, greater than or equal to 15%, greater than or equal to 20%, greater than or equal to 25%, or greater. Combinations of these ranges are possible. For example, in some embodiments, the heat treated metal alloy includes a molar proportion of the austenitic phase that is greater than or equal to 0% and less than or equal to 30%. Other ranges, both higher and lower than those described above, are also possible, as the disclosure is not so limited. The above-mentioned phase fractions may be found within a tool steel alloy before or after tempering of the tool steel alloy, depending on the embodiment. For example, in some embodiments, the proportion of the austenitic phase in the metal alloy is low because of a high proportion of δ-ferrite stabilization as discussed above. In other embodiments, the proportion of the austinitic phase in the metal alloy is low because the metal alloy is heat treated at a temperature below a stable austinite temperature, converting the austenitic phase into other thermodynamic phases.

Metal powders subjected to melting and re-solidification during additive manufacturing processes undergo recrystallization. Accordingly, to provide a desired grain size in the alloy of a manufactured part, it may be desirable to include grain refiners in an alloy as disclosed herein, in some embodiments. The grain refiners may be pinning oxides and/or inoculants as detailed below. The use of grain refiners may help provide a desired grain size during solidification and/or prevent grain growth during heat treatment.

In some embodiments, an alloy may include a pinning oxide such as various rare earth oxides. Non-limiting examples of pinning oxides include lanthanum oxide, cerium oxide, yttrium oxide, and/or combinations of the forgoing. In some embodiments, the oxides may be formed in the material by including a desired proportion of a metal, such as the metal of the pinning oxide, and/or a material that includes combinations of the above-mentioned pinning oxides, such as a mischmetal. The metal or mischmetal may then react with oxygen in the alloy to form the desired pinning oxide, in some embodiments. In some instances, an oxide (e.g., a pinning oxide) used in the alloy may be soluble in the alloy melt. In some embodiments, the ratio of the rare earth metal and oxygen in the alloy melt may be approximately equal to a stoichiometric ratio between the rare earth metal and oxygen in the alloy.

Depending on the embodiment, the rare earth oxide(s) may have a molar phase fraction of between 0.1% and 0.4%, or more preferably about 0.3%, though other proportions may also be provided. Ranges interior to this range are also possible. For example, in some embodiments, the rare earth oxide(s) have a molar phase fraction of greater than or equal to 0.1%, greater than or equal to 0.15%, greater than or equal to 0.2%, greater than or equal to 0.25%, greater than or equal to 0.3%, greater than or equal to 0.35%, or greater. In some embodiments, the rare earth oxide(s) have a molar phase fraction of less than or equal to 0.4%, less than or equal to 0.35%, less than or equal to 0.3%, less than or equal to 0.25%, less than or equal to 0.2%, less than or equal to 0.15%, or less. Combinations of these ranges are possible. For example, in some embodiments, rare earth oxide(s) have a molar phase fraction of greater than or equal to 0.1% and less than or equal to 0.4%. Other ranges, both higher and lower than those described above, are also possible, as the disclosure is not so limited.

In addition, or as an alternative, to the use of pinning oxides such as rare earth oxides, an alloy may also include inoculants such as Titanium nitride TiN, Titankarbonitride Ti(C,N), Titancarbide TiC, Titandiboride TiB₂, and Zirconiumnitride ZrN. The inoculants can, in some embodiments, precipitate out of the melt or be provided as a separate powder mixed with the metal powder. The use of inoculants may alter the resulting microstructure during solidification and/or heat treatment. In some embodiments, an inoculant may be formed by a reaction between a metal, such as titanium, in the alloy and nitrogen present in the alloy due to a manufacturing process as noted above.

A mole fraction of the inoculant in the alloy may be between or equal to 0.1% and 0.4%, or more preferably about 0.3%, though other proportions may also be provided. Ranges interior to this range are also possible. For example, in some embodiments, the inoculant has a molar phase fraction of greater than or equal to 0.1%, greater than or equal to 0.15%, greater than or equal to 0.2%, greater than or equal to 0.25%, greater than or equal to 0.3%, greater than or equal to 0.35%, or greater. In some embodiments, the inoculant has a molar phase fraction of less than or equal to 0.4%, less than or equal to 0.35%, less than or equal to 0.3%, less than or equal to 0.25%, less than or equal to 0.2%, less than or equal to 0.15%, or less. Combinations of these ranges are possible. For example, in some embodiments, inoculant has a molar phase fraction of greater than or equal to 0.1% and less than or equal to 0.4%. Other ranges, both higher and lower than those described above, are also possible, as the disclosure is not so limited.

In some embodiments, a part formed from a disclosed alloy may be subjected to an appropriate post formation heat treatment. A heat treated alloy may include nano scale transition metal carbide precipitates distributed throughout the alloy microstructure. The nano scale transition metal carbide precipitates distributed throughout the alloy microstructure may affect the grain size of the alloy microstructure by any of a variety of mechanisms. For example, without wishing to be bound by any particular theory, the transition metal carbide precipitates could pin grain boundary motion by Zener pinning, or could serve as nucleation sites for alloy grains. The transition metal carbide precipitates could be, for example, M₂C precipitates having any of a variety of appropriate sizes. The M₂C precipitates within the grains of the metal alloy may have an average size that is between or equal to 1 nm and 10 nm. Ranges both interior to and exterior to this range are also possible. For example, in some embodiments, the M₂C precipitates have an average size greater than or equal to 1 nm, greater than or equal to 2 nm, greater than or equal to 5 nm, greater than or equal to 8 nm, greater than or equal to 10 nm, greater than or equal to 12 nm, greater than or equal to 15 nm, greater than or equal to 18 nm, greater than or equal to 20 nm, greater than or equal to 22 nm, or greater. In some embodiments, the M₂C precipitates have an average size less than or equal to 25 nm, less than or equal to 22 nm, less than or equal to 20 nm, less than or equal to 18 nm, less than or equal to 15 nm, less than or equal to 12 nm, less than or equal to 10 nm, less than or equal to 8 nm, less than or equal to 5 nm, less than or equal to 2 nm, or less. Combinations of these ranges are possible. For example, in some embodiments, M₂C precipitates have an average size greater than or equal to 1 nm and less than or equal to 25 nm. Other ranges, both higher and lower than those described above, are also possible, as the disclosure is not so limited. The above-mentioned sizes could also be appropriate for other transition metal carbides.

The alloy could, after formation and heat treatment, have any of a variety of appropriate average grain sizes. For example, an alloy after formation and heat treatment may have an average grain size that is 20 microns or less. Ranges interior to this range are also possible. For example, in some embodiments, the alloy has an average grain size less than or equal to 20 microns, less than or equal to 18 microns, less than or equal to 15 microns, less than or equal to 12 microns, less than or equal to 10 microns, less than or equal to 8 microns, less than or equal to 5 microns, less than or equal to 2 microns, less than or equal to 1 micron, or less. In some embodiments, the alloy has an average grain size greater than microns, greater than or equal to 0.5 microns, greater than or equal to 1 micron, greater than or equal to 2 microns, greater than or equal to 5 microns, greater than or equal to 8 microns, greater than or equal to 10 microns, greater than or equal to 12 microns, greater than or equal to 15 microns, greater than or equal to 18 microns, or greater. Combinations of these ranges are possible. For example, in some embodiments, the alloy has an average grain size of greater than 0.5 microns and less than or equal to 20 microns. Other ranges, both higher and lower than those described above, are also possible, as the disclosure is not so limited.

In some embodiments, the disclosed metal alloys may be provided in the form of a metal powder for use with an additive manufacturing process. For example, a metal powder may be provided with an average particle size that is between or equal to 20 m and 200 m. Ranges interior to this range are also possible. For example, in some embodiments, the average particle size is greater than or equal to 20 μm, greater than or equal to 30 μm, greater than or equal to 50 μm, greater than or equal to 75 μm, greater than or equal to 100 μm, greater than or equal to 150 m, or greater. In some embodiments, the average particle size is less than or equal to 200 μm, less than or equal to 150 μm, less than or equal to 100 μm, less than or equal to 75 μm, less than or equal to 50 μm, less than or equal to 30 μm, or less. Combinations of these ranges are possible. For example, in some embodiments, the average particle size is greater than or equal to 20 m and less than or equal to 200 μm. As another, more specific example, in some embodiments, the average particle size between or equal to 30 μm and 50 μm. Other ranges, both higher and lower than those described above, are also possible, as the disclosure is not so limited. Appropriate manufacturing techniques for forming a metal powder with the disclosed tool steel alloys may include, but are not limited to, inert gas atomization, ultrasonic atomization, water atomization, centrifugal atomization, plasma atomization, and/or any other appropriate formation technique. In some embodiments, an atomization process under a nitrogen atmosphere may be used to provide nitrogen in the metal powder alloy. It should be understood that while particular particle sizes are noted above, other particle sizes both larger and smaller than those noted above may also be used.

The powder materials may be provided using any appropriate method. For example, a powder with a desired size range may be formed from the disclosed alloy materials using ultrasonic vibration atomization, centrifugal atomization, vacuum inert gas atomization, plasma atomization, electrode inert gas atomization, or any of a variety of other suitable methods.

It should be understood that any appropriate heat treatment may be applied to the disclosed tool steels after they have been initially melted and fused to form the desired parts. In some embodiments, a heat treatment may include a solutionizing step where the alloy is held at a temperature between or equal to 1100° C. and 1200° C. for a sufficient time to result in a uniform solutionized material (e.g., 1 to 2 hours). A solutionized material may be quenched at an appropriate rate to provide a desired microstructure. The quench could be an oil quench, a molten salt quench, a water quench (e.g., a fresh water quench, a salt-water quench), or any of a variety of other appropriate types of quench. Following quenching, a tempering step may be performed. This tempering step can be done at a temperature between or equal to 350° C. and 720° C. but is preferably between or equal to 500° C. and 650° C. Ranges interior to this range are also possible. For example, in some embodiments, the tempering step can be done at a temperature of greater than or equal to 350° C., greater than or equal to 380° C., greater than or equal to 400° C., greater than or equal to 420° C., greater than or equal to 450° C., greater than or equal to 480° C., greater than or equal to 500° C., greater than or equal to 520° C., greater than or equal to 550° C., greater than or equal to 580° C., greater than or equal to 600° C., greater than or equal to 620° C., greater than or equal to 650° C., greater than or equal to 680° C., greater than or equal to 700° C., or greater. In some embodiments, the tempering step can be done at a temperature of less than or equal to 720° C., less than or equal to 700° C., less than or equal to 680° C., less than or equal to 650° C., less than or equal to 620° C., less than or equal to 600° C., less than or equal to 580° C., less than or equal to 550° C., less than or equal to 520° C., less than or equal to 500° C., less than or equal to 480° C., less than or equal to 450° C., less than or equal to 420° C., less than or equal to 400° C., less than or equal to 380° C., or less. Combinations of these ranges are possible. For example, in some embodiments, the tempering step can be done at a temperature of greater than or equal to 350° C. and less than or equal to 720° C. Other ranges, both higher and lower than those described above, are also possible, as the disclosure is not so limited.

This tempering step may last between or equal to 2 hours and 10 hours. Ranges interior to this range are also possible. For example, in some embodiments, the tempering step may last for greater than or equal to 2 h, greater than or equal to 3 h, greater than or equal to 4 h, greater than or equal to 5 h, greater than or equal to 6 h, greater than or equal to 7 h, greater than or equal to 8 h, greater than or equal to 9 h, or greater. In some embodiments, the tempering step may last for less than or equal to 10 h, less than or equal to 9 h, less than or equal to 8 h, less than or equal to 7 h, less than or equal to 6 h, less than or equal to 5 h, less than or equal to 4 h, less than or equal to 3 h, or less. Combinations of these ranges are possible. For example, in some embodiments, the tempering step may last for greater than or equal to 2 h and less than or equal to 10 h. Other ranges, both higher and lower than those described above, are also possible, as the disclosure is not so limited.

Tempering could include a multiple step tempering process, such as a double tempering process in order to avoid retained austinite. More generally, any of a variety of appropriate tempering steps (e.g., 1, 2, 3, 4, 5, 6, 7, 8, 9, 10, or more tempering steps) may be performed under the aforementioned temperature ranges and tempering times. Of course, other appropriate heat treatments may be used with the disclosed alloys as the disclosure is not limited in this fashion.

The disclosed tool steels may be used in any number of additive manufacturing processes. For example, metal additive manufacturing can be used in the tooling industry through the use of one or more tool steels disclosed herein. Other manufacturing processes may also benefit from the use of tool steels disclosed herein, including high-pressure die-casting (HPDC). Die-casting of disclosed alloys may facilitate additional treatment techniques such as contour-near cooling that can be implemented using the dies. Of course, other applications of the disclosed metal alloys are also contemplated.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

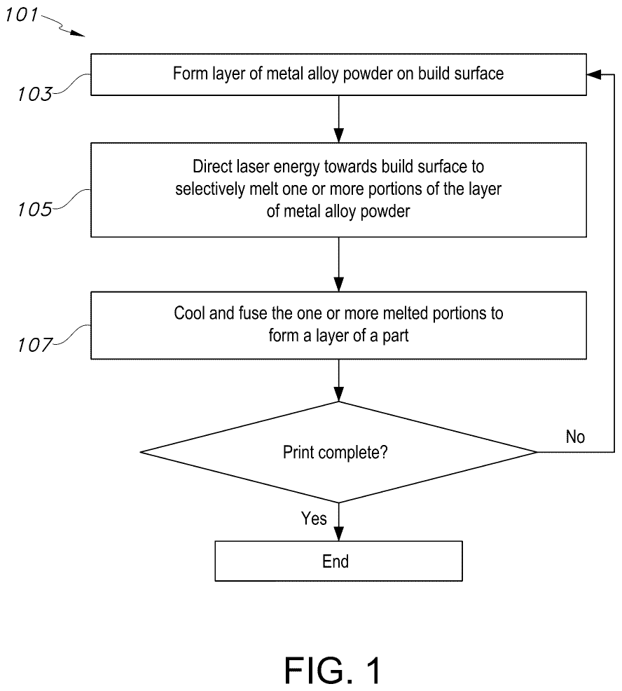

FIG. 1 presents a non-limiting schematic representation of method 101 of additively manufacturing a metal alloy described herein, according to some embodiments. In a first step 103, a first layer of the metal alloy powder is formed on a build surface, The layer may be formed using any of a variety of appropriate methods. For example, the layer may be formed by depositing the metal alloy powder and spreading it to form the layer using a recoater roller or blade. Other layer formation steps are also possible, as the disclosure is not so limited. The method further includes step 105 of directing laser energy, or other types of energy, towards a build surface to selectively melt one or more portions of the layer of metal alloy powder. The laser energy may be directed to the surface by rastering the laser source, using guiding optics, or a combination thereof. In a third step 107, the one or more melted portions are cooled, fusing the metal alloy to form a layer of a part. The metal alloy may be solidified at a rate described above. In some embodiments, the fused metal alloy has a high concentration of chromium and/or comprises a high phase fraction of δ-ferrite, as described above. Method 101 may then be terminated if the print is complete or iterated if the print is incomplete, as indicated in the figure. For example, the layer formation and selective powder fusion may be repeated any number of times to form the different layers of a part to be formed with the metals. Of course, it should be understood that while method 101 represents one method for manufacturing a metal alloy, the disclosure is not so limited, and the metal alloys described herein may be manufactured using any of a variety of other suitable methods, as the disclosure is not so limited.

### Example 1: Steel Compositions

This Example demonstrates the design and validation of steel alloys suitable for additive manufacturing processes. In this example, non-limiting metal alloys with high chromium content were identified and tested, demonstrating improved performance.

Computational modeling was used to model the thermodynamics and kinetics of various metal alloys, in order to identify useful compositions and heat treatments. The Calculated Phase Dynamics (CALPHAD) method, interfaced with thermo-chemical models via the software Thermo-Calc Version 2021a, was used to identify a printable metal alloy. The employed thermodynamic database was TCFE10. The kinetic mobility database MOBFE5 was also utilized during Scheil calculations to activate back diffusion for the interstitial C. Moreover, C was set as a fast diffuser. Thermochemical models regarding coarsening rate, hardness, and martensite start temperature were interfaced with the thermodynamic calculations and incorporated within MADE, a proprietary software developed by QuesTek Innovations LLC. Modeling was used to identify metal alloys with a predicted hardness of at least 44 HRC combined with a predicted Charpy impact energy of at least 13.55 J cm⁻², which would have a superior grade after solutionizing and double tempering at 590° C.

To model strengthening, a linear, semi-empirical Vickers hardness model mainly considering the M₂C driving force was employed to connect hardness with chemical composition and microstructural properties. Precipitation strengthening via finely dispersed M₂C carbides can contribute to strengthening secondary hardening steels, so production of finely dispersed M₂C carbides was prioritized. The precipitates' nano-scale dispersion was achieved by maximizing the driving force for nucleation, thereby reducing the critical nucleation size of the precipitates, and reducing expected precipitate size. Vickers hardness was approximated by the equation:

$$HV = {K}_{1} + {K}_{2} \vert Δ {G}_{coherent}^{{M}_{2} C} \vert \sqrt{{f}_{M + C}}$$

Where HV is the total hardness in the Vickers hardness model; K₁ is a calibrated strength contribution depending on composition, dislocation density, and martensite; K₂ is a calibrated constant related to precipitation hardening of H10;

$$Δ {G}_{coherent}^{{M}_{2} C}$$

is the M₂C coherent driving force; and f_{M+C} is the volume fraction of M₂C at half completion compared to the equilibrium condition. K₁ was deduced by using a carbon-free steel Fe-0.003C-10Ni wt % tempered at 520° C., revealing a hardness of 185 HV with a M₂C driving force of 0 kJ/mol:

$${K}_{1} = {τ}_{{α}^{′}} + {τ}_{D} + {τ}_{SS} ≡ 185 HV$$

where τ_{α′} is the strength contribution for martensite, τ_{D} is the strength contribution for dislocation density, and τ_{SS} is the strength contribution for a solid solution. K₂ was determined using the peak hardness value of quenched and tempered H10 at 480° C., i.e., 510 HV. Vickers hardness was selected for the hardness calculations rather than Rockwell hardness based on the linear scale; a conversion from Rockwell to Vickers was conducted by interpolating ASTM Standard E120-12. Again, the specific M₂C driving force for the H10 tool steel was calculated for K₂. Thus, connecting both constants, K₁ and K₂, the slope allowed a linear extrapolation by maximizing the M₂C driving force and the Vickers hardness accordingly for the printable matrix tool steel at an optimized coherent M₂C driving force.

The free energy of coherent driving force for M₂C was treated as a summation of four factors: Gibbs free energy, elastic energy, interfacial energy, and interaction energy:

$$Δ {G}_{coherent}^{{M}_{2} C} = {G}_{chemical} + {G}_{elastic} + {G}_{interfacial} + {G}_{INT}$$

At peak hardness, the precipitate diameter that was expected to most strongly resist dislocation motion corresponded to the shear/bypass transition size, or the smallest particle whose dislocation resistance was governed by the Orowan relation. The smallest particle whose dislocation resistance was governed by the Orowan relation had a diameter of approximately 3 nm. Therefore, the coherent M₂C driving force model was applied.

As an extended constraint to the driving force calculations using ThermoCalc, a ferrite/cementite para-equilibrium condition was defined for the initial carbide precipitation by selecting cementite as a dormant phase based on the increased mobility of C as an interstitial element compared to the substitutional elements. Cementite precipitates at an early stage during tempering, leading to a meta-stable equilibrium of the BCC matrix and this carbide. Overall, the para-equilibrium state defined the precipitation sequence at which cementite was the starting condition for the other carbides. Additionally, at secondary hardening, cementite precipitation was approximated to be completed. The substitutional elements (Fe, Cr, Mo, V, W) and the interstitial element C were modeled on separate sublattices.

During quenching from the γ-austenite at solutionizing temperature, lath martensite was produced by diffusionless transformation to a body-centered tetragonal α′ structure. The Gosh and Olson model was utilized to determine the martensite start temperature. The martensite nucleus was treated as a group of coherent and anti-coherent dislocations which must overcome a frictional force to propagate. The martensitic transformation from γ to α′ evolved when the frictional work contribution was exceeded. The frictional barrier was modeled as a function of the composition of the matrix.

Because small particle sizes are desired, coarsening resistance can be advantageous for metal alloys. As such, precipitate coarsening or Ostwald ripening was modeled by estimating the rate constant for coarsening kinetics using the α matrix composition, the diffusivit and partitioning coefficients of each element M, the interfacial energy of the precipitate interface, and the molar volume of the carbide.

The required undercooling for the growth of δ-ferrite on the surface of TiN precipitates was calculated by the following equation:

$$Δ {T}_{fg} = \frac{4 Γ}{d} = \frac{4 {σ}_{SL}}{Δ {S}_{v} d}$$

where F is the Gibbs-Thomson coefficient, d is the particle diameter, σ_{SL} is the solid-liquid interfacial energy, and ΔSᵥ is the entropy of fusion per unit volume. The ratio between σ_{SL} and ΔSᵥ(F) determines the undercooling needed for the onset of free growth of given TiN inoculant particles.

To reduce undesirable grain coarsening of the austenite grains at the non-limiting solutionizing temperature of 1100° C., the Zener pinning was modeled using an empirically defined grain size distribution, the expected particle size distribution, the particle volume fraction, and the recrystallized prior austenite grain size. Alloys with higher Zener pinning may be associated with reduced grain coarsening.

Using the modeling approaches described above, various compositions of steel were modeled and evaluated for potential effectiveness as additively manufacturable tool steels.

Computationally designed chemical composition of the experimentally validated die steels “Prototype 1” and Prototype 2” are shown in Table 1.

TABLE 1
Composition of Prototype 1 and Prototype 2 steel.

| Element | | C | Cr | Mo | V | W | P | S | Ti | La | N | O | Fe |
|---|---|---|---|---|---|---|---|---|---|---|---|---|---|
| Prototype 1 | mol.-% | 1.40 | 8.5 | 2.2 | 0.70 | 0.20 | — | — | 0.33 | — | 0.30 | 0.03 | Rest |
| | wt.-% | 0.30 | 7.9 | 3.8 | 0.64 | 0.66 | — | — | 0.28 | — | 0.08 | 0.01 | Rest |
| Protoype 2 | mol. % | 2.30 | — | 2.775 | 1.675 | 0.15 | ≤0.002 | ≤0.001 | 0.30 | 0.03 | 0.30 | 0.14 | Rest |
| | wt.-% | 0.50 | — | 4.76 | 1.525 | 0.49 | ≤0.002 | ≤0.001 | 0.25 | 0.08 | 0.08 | 0.04 | Rest |

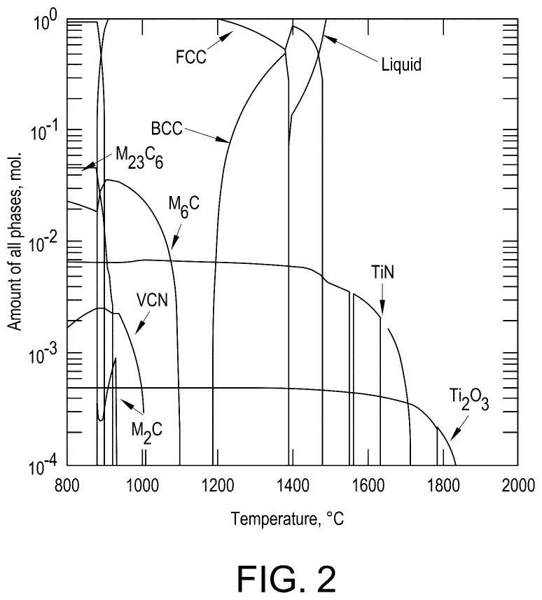

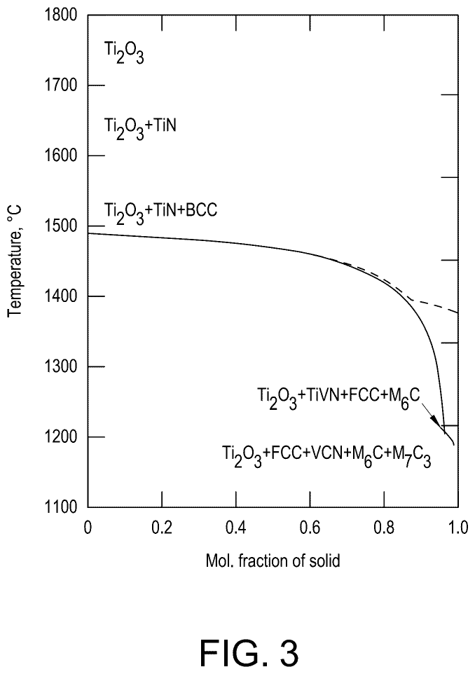

FIG. 2 is a step diagram of die steel for Prototype 1. FIG. 2 shows the relative phase fraction of each phase of Prototype 1 steel as a function of temperature, as predicted by the model. FIG. 3 is a Scheil diagram of die steel for Prototype 1.

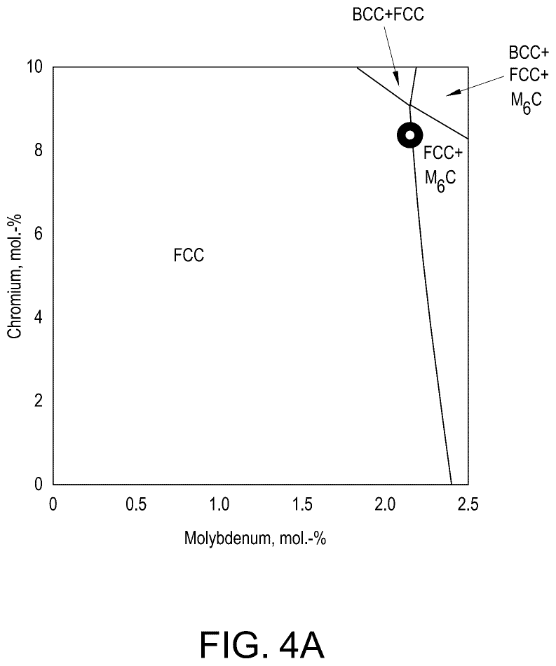

FIG. 4A is a phase-diagram at 1100° C. of Prototype 1 steel (indicated by the position of the bold circle). FIG. 4B is a Scheil cross-plot revealing 6-ferritic solidification as a function of Mo and Cr. The Scheil cross-plot of FIG. 4B is shown on the same axis as the phase-diagram of FIG. 4A, and shows the amount of δ-ferrite (amount of BCC) expected as a function of the mol % of Mo and Cr. FIG. 4B and indicates the composition of Prototype 1 steel using the same bold circle as FIG. 4A. As indicated by comparing FIGS. 4A-4B, Prototype 1 steel admits a high concentration of Cr and Mo without introducing significant amounts of FCC or M₆C phases when solutionized at 1100° C. Moreover, Prototype 1 steel is projected to retain a high phase fraction (0.92-0.96) of δ-ferrite, as shown in FIG. 4B. These features are believed to be advantageous for improving the mechanical properties of printed Prototype 1 steel.

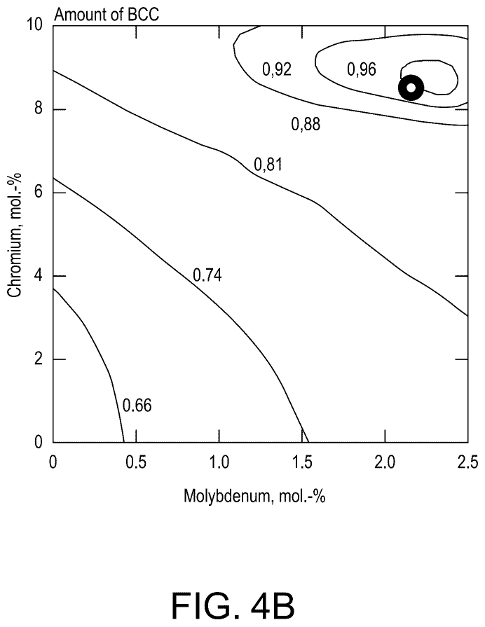

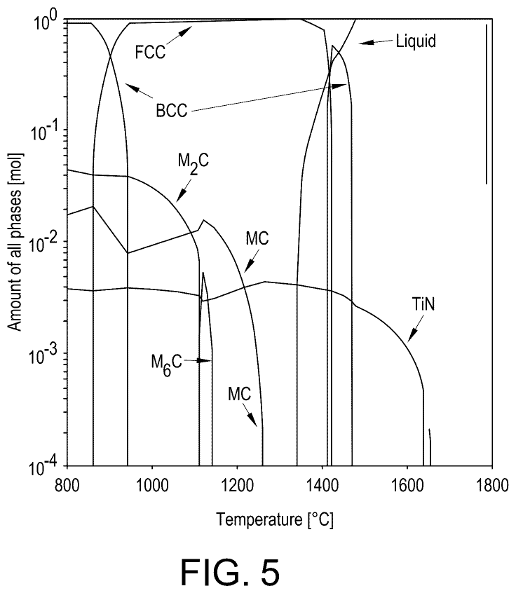

FIG. 5 is a step diagram of die steel “Prototype 2”. FIG. 6 is a Scheil diagram of die steel “Prototype 2”.

### Example 2

This example compares the properties and performance of Prototype 1 steel with the properties of H13 tool steel (provided as a comparative example). Sample specimens of H13 were made using laser powder bed fusion (LPBF). The LPBF machine applied was calibrated and verified according to ISO/ASTM DIS 52941:2019. The hot working tool steel was processed employing a gas-atomized powder material with a particle size distribution (PSD) between 15 μm and 45 μm and the following volume percentages: d10=9.5%, d50=25.6%, and d90=64.6%. The LPBF machine possesses an Nd:YAG-laser capable with a maximum laser power of 400 W operating at a wavelength of 1064 nm. The laser focus was adjusted to 70 μm in addition to a dynamic focusing unit allowing a constant laser focus over the baseplate dimension. A preheating temperature of 200° C. was selected, and the LPBF processing parameters were as follows: laser power 250 W, hatch distance 120 μm, scan speed 700 mm s⁻¹, layer thickness 50 μm, scan strategy 8 mm stripes, and rotation of 67°. During LPBF processing, Argon 4.6 was employed as an inert gas atmosphere with a residual O₂ level <1000 ppm. Additionally, before LPBF processing, the powder material was vacuum dried to reduce the relative humidity of the powder material <5% utilizing an in-house-developed system.

Specimens of Prototype 1 steel were also made via gas atomization and LPBF processing. First, a small-batch vacuum inert-gas atomizer was employed using a closed-couple nozzle system (AU 3000, BluePower Casting). Multiple vacuum-melted pre-alloyed FeC steel cuboids with size of 30 mm×30 mm×30 mm and a C content of 0.28 wt-%, determined using optical emission spectroscopy (Q4 Tasman Series 2, Bruker AXS), were placed in the Al₂O₃-crucible as well as pure Cr, V, Mo, W, and Ti in granulate or flake shape to achieve the desired chemical composition. Before inductive heating, the sealed crucible was vacuum pumped and subsequently flooded with Ar to avoid oxidation during melting. An O₂ content <30 ppm was achieved using the Ar flooding. The steel was superheated at 1750° C. under Ar atmosphere. After 10 min of homogenization, pure La was added through a valve chute under Ar atmosphere. The diameter of the delivery melt tube nozzle was 2 mm, and the mean melt flow rate was set to 265 kg h⁻¹. Next, N₂ at RT with a pressure of 28 bar was used to disintegrate the liquid metal and a gas mass flow rate of 583 kg h⁻¹. Thus, a gas-to-melt ratio of ≈2.2 was obtained. A total amount of 1.5 kg unsifted and unsighted powder material was manufactured. Lastly, the powder was sighted to remove large powder particles and splash. The utilized powder material possessed a PSD of d10=8.56%, d50=24.41%, and d90=65.76%.

Specimens of Prototype 1 steel were fabricated by LPBF employing an SLM 250 HL LPBF machine (SLM Solutions) equipped with a 400 W Nd:YAG laser with a wavelength of 1064 nm. The SLM 250 HL was calibrated following TSO/ASTM DIS 52941:2019. The laser profile was employed as a Gaussian distribution. The preheating temperature was set to 200° C. Ar was used as an inert gas in the build chamber with a residual oxygen level of 1000 ppm. LPBF process parameters were intentionally selected from the default 316L parameter set provided by the LPBF machine manufacturer to demonstrate the simple LPBF processing of the Prototype 1 steel designed. The LPBF processing parameters were as follows: laser power at 275 W, scan speed at 750 mm/s, hatch distance at 120 μm, layer thickness of 50 μm, scan strategy 8 mm stripes, and rotation of 67°. Applying these processing parameters, 40 cuboids 6 mm×6 mm×6 mm in size were manufactured and utilized for the solutionizing and the tempering studies.

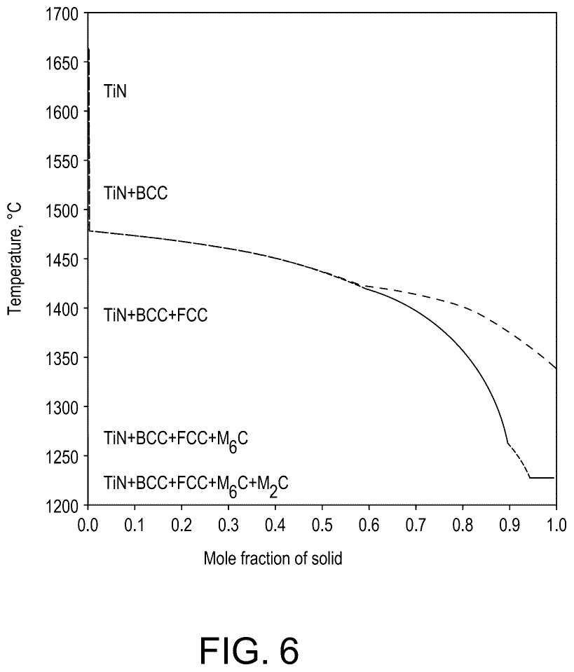

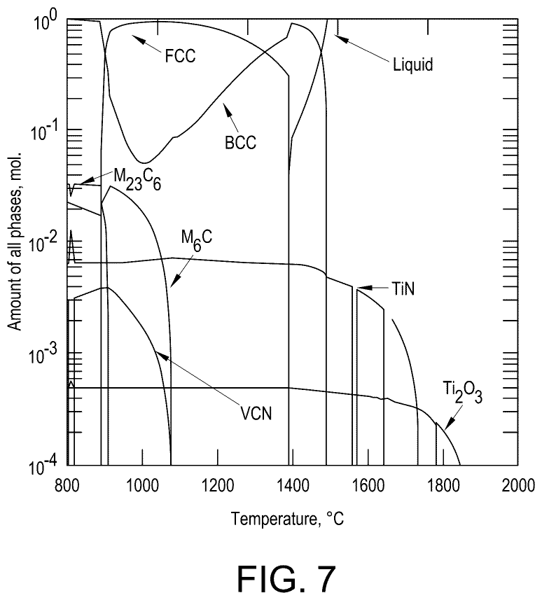

Light microscope investigations were performed, along with relative density investigations using VCT (SkyScan 1275, Bruker) with a voxel size of 6 μm. A high relative density of 99.99% demonstrates appropriate LPBF processing parameters The chemical compositions of the samples were measured via optical emission spectroscopy Q4 Tasman (Bruker) and hot gas extraction. Employing the latter technique, the elements P, S, O, and N were detected in the as-atomized and as-printed conditions. The composition of the Prototype 1 steel was measured as-printed and as-atomized, in order to observe any changes in composition. The as-printed composition possessed a reduced C-content of 1.12 mol. % instead of the 1.4 mol.-% C-content in the as-designed composition, leading to a distinct δ-ferrite stabilization at equilibrium. Table 2 compares the composition of the Prototype 1 steel (as initially designed) with the composition of the as-atomized and as-printed steel. FIGS. 7-8 are, respectively, a step plot and a Schiel plot of as-printed Prototype 1 steel. FIGS. 7-8 are comparable to FIGS. 2-3 described above, but computed for the as-printed composition, rather than for the as-designed composition. As shown in FIGS. 7-8, the phase-behavior of the as-printed Prototype 1 steel was similar to the predicted phase-behavior of the as-designed Prototype 1 steel, so the changes in composition during processing were not expected to significantly change mechanical performance of the steel.

TABLE 2
Composition of Prototype 1 steel as-designed, as-atomized,
and as-printed. The balance of each composition is Fe.

| Element | | C | Cr | Mo | V | W | P | S | Ti | La | N | O |
|---|---|---|---|---|---|---|---|---|---|---|---|---|
| Prototype 1 | mol % | 1.4 | 8.5 | 2.2 | 0.7 | 0.2 | — | — | 0.33 | — | 0.300 | 0.03 |
| as-designed | wt % | 0.30 | 7.9 | 3.8 | 0.64 | 0.66 | — | — | 0.28 | — | 0.080 | 0.01 |
| As-atomized | mol % | 1.12 | 8.0 | 2.2 | 0.74 | 0.20 | ≤0.002 | ≤0.001 | 0.33 | 0.03 | 0.419 | 0.14 |
| | wt % | 0.24 | 7.4 | 3.8 | 0.67 | 0.69 | ≤0.002 | ≤0.001 | 0.28 | 0.08 | 0.105 | 0.04 |
| As-printed | mol % | 1.12 | 8.2 | 2.2 | 0.74 | 0.19 | ≤0.002 | ≤0.001 | 0.33 | 0.09 | 0.368 | 0.03 |
| | wt % | 0.24 | 7.6 | 3.8 | 0.67 | 0.65 | ≤0.002 | ≤0.001 | 0.29 | 0.12 | 0.092 | 0.01 |

The printed Prototype 1 steel and H13 steel were heat treated by dividing printed samples of each steel into two groups based on solutionizing and tempering procedure. By dissolving all carbides at the selected solutionizing temperature at 1100° C., the total C-content was dissolved in the austenitic γ-matrix that was then entirely available for the martensitic α′-transformation during quenching. At the solutionizing temperature, only the high melting TiN inoculants produced Zener drag. It was observed that advantageously, by increasing the solutionizing temperature from 1030° C. (the solutionizing temperature conventionally used for H13) to 1100° C., higher solubility of alloying elements in the γ-matrix was achieved. An α′-ferritic matrix with a Mₛ-temperature between 200° C. and 300° C. was obtained during quenching to RT, transforming to lath martensite and assessed in correlation with the selected carbide formers fractions. Lath martensite possesses a higher toughness than plate martensite and, furthermore, leads to a high dislocation density preferential for heterogeneous nucleation of M₂C during tempering. Thus, the transformation to Lath martensite was an advantage for the mechanical performance of the Prototype 1 steel.

For secondary hardening, a stage four tempering treatment in the range of 450° to 600° C. resulted in the decomposition of α′-martensite into α-ferrite. Precipitation of coherent metastable M₂C and stable MC carbides also occurred in the prototype 1 tool steel, providing additional mechanical advantages. Initially, transient cementite Fe₃C was precipitated during tempering of the Prototype 1 steel based on the high mobility of the interstitial C. However, M₂C and MC became the dominant carbide phase during tempering. Thus, during secondary hardening, the tempering process resulted in the formation of the nano-scale M₂C carbides that can mechanically strengthen the steel, as predicted via modeling.

In order to identify the types of cracking in the as-printed H13 condition and the microstructure in the as-printed and heat-treated Prototype 1 steel design, light microscopy images were taken in reflection using a VHX5000 light microscope (Keyence; Axiophot, Zeiss). The optical microscopy performed on 10 mm×10 mm×30 mm cuboids of the printed compositions showed that nearly defect-free specimens were fabricated. The LPBF standard process parameter for austenitic stainless steel 316L was employed, and mainly shallow to semicircular melt pool shapes were detected. This evidenced a stable LPBF processing condition of steels known as conduction mode welding. Occasionally, narrow and deep melt pools indicated a keyhole welding mode. The keyholing was attributed to a so-called burn-in effect caused by the scanner-laser beam guidance system at the beginning of a new vector that must be scanned solidification cracks were not be detected in the light microscopical images.

Crack morphology and fracture surface analysis was conducted utilizing a field-emission scanning electron microscope (FE-SEM) (Ultra Plus, Zeiss) with a secondary and an in-lens detector. Crystallographic and morphologic grain structures were analyzed via an electron backscatter diffraction (EBSD) detector (DigiView EBSD Camera, Ametek), giving insight into the as-atomized, as-printed, and heat-treated condition required to conclude the effect of TiN inoculants as potential grain refiners. All EBSD measurements were conducted with the following setup: acceleration voltage of 20 keV using a 120 μm aperture and an exposure time of 0.12 ms at a step size of 40 nm with a binning of 4×4. Based on the Kikuchi patterns measured via EBSD, the α and γ phases were determined. The EBSD data collected was assessed and visualized employing MTEX v5.2.8 crystallographic Toolbox integrated into Matlab R2018b. An energy-dispersive X-ray spectroscopy (EDS) detector (Octane Elite, Ametek) was employed using point measurements at 10 keV for 60 s, guaranteeing at least 6000 counts to verify precipitates in the atomized powder material.

The measured EBSD orientation map confirmed the absence of micro-cracks in the as-printed Prototype 1 steel. The solidification cracking and reheat cracking likely resulted from stabilization of δ-ferrite in the as-printed Prototype 1 steel, relative to the H13 steel. As predicted in the calculations shown in FIG. 4B, a δ-ferrite content of approximately 92% was present in the Prototype 1 steel, likely as a result of chromium stabilization. Occasionally, austenite was detected in the weld bead center, as predicted. However, in the heat-affected zone (HAZ), the precipitation of austenite at the interdendritic regions occurred. Based on the equilibrium step-diagram, the HAZ must have been exposed to a temperature >900° C. such that 7-austenite started to precipitate. The two-phase arrangement can also be detected at the V2A etched light microscopical image, in which the brownish-colored regions indicate austenite phase and the bright regions indicate δ-ferrite.

An additional contributor to the reduction in solidification cracking of the as-printed Prototype 1 steel, relative to the H13 steel, was the grain refinement of the Prototype 1 steel. In the Prototype 1 steel, a bimodal grain size distribution consisting of short cellular grains and small equiaxed grains was identified. The columnar solidification mode initiated the melt pool boundaries and transformed to an equiaxed growth towards the melt pool center. The cellular grains evolved in the opposite direction to the heat flow initiating from the melt pool bottom. Subsequently, fine dendritic grains nucleated ahead of the solidification front, impeding the columnar growth. The grain size at this condition ranged from approximately 1 μm to 10 μm, representing a reduction of approximately one potency compared to LPBF processed H13 grain. Therefore, the crystallographic and morphological anisotropy expanding over multiple layers was inhibited, and the susceptibility for solidification cracking was minimized. Accordingly, an isotropic grain orientation was achieved based on the grain refinement.

A three-dimensional impression of the volume fraction, size, and dispersion of the nano-scale TiN inoculant particles in the as-printed parts was obtained using a focused ion beam (FIB) with a Ga liquid metal ion source (LMIS) integrated into the FE-SEM (NEON 40, Zeiss). At an area of approximately 8 μm×8 μm, a slice-and-view procedure was applied with a 5 nm step over a total depth of 5 μm. The FIB ion beam operated at 30 kV, whereas the FE-SEM electron beam operated at 2 kV capturing high-resolution images via an in-lens detector. The required SEM image post-processing and the subsequent 3D reconstruction of the SEM images were realized using visualization software (Avizo, FEI Group). A three-dimensional localization of the precipitated TiN inoculants was determined based on reconstructed FIB-SEM slices at a region in which the transition from columnar to equiaxed solidification mode occurred. Overall, similar to the distribution in the powder particles, the TiN inoculants were homogeneously distributed in the LPBF processed as-printed microstructure. It was hypothesized that the fine TiN inoculants present in the powder material dissolve and reprecipitate during LPBF-processing. The TiN inoculants were detected intra and intergranular, in which the latter position indicated an effective catalyst for grain refinement. However, at the solid/liquid (S/L) interface, most TiN particles were dragged to the grain boundaries without contributing to the nucleation of δ-ferritic grains. Still, the intragranular TiN inoculants were a strong barrier to impede grain growth during LPBF processing and solutionizing by Zener pinning. A nano-sized particle range between 30 nm to 180 nm was observed in the FIB-SEM 3D reconstruction.

An in-depth analysis of the grain refinement mechanism between the δ-ferrite grains and the TiN inoculants and the characterization of the carbides precipitating during heat treatment was obtained by transmission electron microscopy (TEM). Specimens for TEM investigation were electrolytically thinned foils. To obtain the TEM-foils, initially, slices were extracted by saw cutting from the specimen parallel to the building direction (BD). These slices were then ground down to a thickness of approximately 150 m. Afterward, a twin-jet electropolisher (LectroPol-5, Struers) utilizing a 5-% perchloric acid in ethanol solution under an applied potential of 25 V at −40° C. was applied until electron transparency was achieved. The TEM measurements were conducted at a nominal acceleration voltage of 200 kV on a JEOL JEM-ARM200F probe-side Cs-corrected microscope equipped with a Gatan 4096×4096 pixel OneView camera for TEM imaging and a JEOL SDD detector for EDS analysis.

The chemical composition of the precipitated TiN inoculants was analyzed in the powder, and it was determined that a core-shell architecture existed. The core consisted of Ti and N, as well as V, and the remaining carbide formers Cr, W, Mo were enriched at the shell. The ternary precipitation may have resulted from the underbalanced Ti:N ratio that resulted in excess N gettering V. In the as-printed condition, a comparable Ti:N under-balance existed. The Scheil solidification curve revealed the precipitation sequence from TiN to TiVN. Hence, even though ternary TiVN precipitates were observed in the as-printed condition, TiN precipitates at the S/L interface drove the heterogeneous nucleation and only later transformed to TiVN.

Carbides could not be detected in the as-printed Prototype 1 steel. The HR-TEM images and the corresponding Fast Fourier Transform (FFT) analyses showed the face-centered cubic crystal structure of TiVN and the orientation relationship with the body-centered δ-ferritic matrix. The theoretical misfit between δ-ferrite and TiN was calculated as 4.1%. Based on the size distribution of TiN and the misfit calculated, a theoretically required undercooling was determined. In this study, the undercooling for heterogeneous nucleation on the TiN catalyst particles was assessed by the free growth undercooling model ΔT_{fg} from Greer et al. in combination with the undercooling nucleation model ΔTₙ from Turnbull and Vonnegut. The ΔT_{fg} model described the projected undercooling that would cause nucleation at the S/L front of the melt pool as a function of particle diameter; the smaller the particles, the higher the projected undercooling. The nucleation undercooling ΔTₙ describes the lattice misfit between the nucleate and the solidifying matrix. A reduced lattice misfit may lead to a decreased interfacial energy, lowering the undercooling projected to result in equiaxed grain growth. The Greer model and the Turnbull and Vonnegut model were cumulated to estimate the undercooling required for grain refinement. It was estimated that a comparably low undercooling was needed for all particle sizes evolved to catalyze heterogeneous grain refinement.

For hardness testing, specimens were warm-embedded in conductive resin. To remove a possible decarburization zone at the specimens, 2 mm samples were ground by employing a stone disc grinding procedure within the Hexamatic (Struers). Finally, a V2A etchant (15-20% hydrochloric acid, 1-5% nitric acid) solution was employed to observe the grain morphology and carbide distribution via microscopy analyses. The experimental characterization of the mechanical performance was determined by Vickers macro-hardness measurements utilizing a force of 100 N (KB 30 FA, KB Prüftechnik) in as-printed, solutionized, and solutionized plus tempered condition. For each specimen, 10 indentations were conducted adhering to DIN EN ISO 6507.

Macro-hardness values were determined for different solutionizing temperatures starting from 950° C. up to 1200° C. for 30 min, as well as the as-printed hardness of the Prototype 1 steel and the LPBF-printed H13. Concerning both as-printed conditions, the designed tool steel possesses a drastically reduced hardness of 375 HV10. Furthermore, a peak hardness of approximately 575 HV10 was achieved in the solutionizing temperature range from 1100 C to 1150° C. In this temperature range, primary carbides were dissolved, and only the fine TiVN particles remained as precipitates. As a result of the dissolution of the carbides, all carbon in the steels was available for martensitic transformation during oil quenching. At solutionizing temperatures below 1100° C., primary carbides remained, resulting in a reduced hardness due to undissolved primary precipitates in the austenitic matrix. On the other hand, extensive grain coarsening was identified at 1200° C., resulting in a slightly reduced hardness compared to the designed temperature at 1100° C. Therefore, the solutionizing temperatures at 1100° C. and 1150° C. were identified as advantageous for treating Prototype 1 steel. The Prototype 1 steel has a superior peak hardness of 530 HV10 was achieved at 480° C., compared to the hardness of conventional hot working steel H10.

### Example 3

This example describes mechanical properties of heat treated Prototype 1 steel samples prepared in Example 2, as well as the measured mechanical properties associated with heat treated Prototype 1 steel. Miniature tensile tests were performed using a servo-hydraulic test frame (858 Table Top, MTS Systems) with a 15 kN load cell at a constant displacement rate of 0.025 mm/s under room temperature. The loading direction was perpendicular to BD based on the limited powder material available. Complementary to the miniaturized specimen dimension, a subminiature extensometer (632.29F-30, MTS Systems) with a gauge length of 5 mm and a strain region up to +50% was utilized. For tensile testing, cuboids were printed with edge lengths of 15 mm×9 mm×30 mm to cut miniaturized tensile test specimens via electric discharge machining (EDM). The quasi-static response under tensile load was measured for a solutionizing temperature at 1100° C. and three different tempering temperatures. μCT relative density scans displayed an almost defect-free gauge section of the miniature-sized specimens.

The peak hardness condition for Prototype 1 steel resulted from tempering at 520° C. The Prototype 1 steel tempered at 520° C. demonstrated an ultimate tensile strength of 1800 MPa with an elongation at fracture of 13%. The high elongation at fracture and the fracture surface of the Prototype 1 steel tempered at 520° C. indicated that solidification cracking was eliminated. A similar ultimate tensile strength was observed for Prototype 1 steel tempered at 560° C., although the steel possessed a marginally lower elongation of 12% at fracture. Conversely, at Prototype 1 tempered at 580° C., the ultimate tensile strength was 1400 MPa, but the elongation at fracture was increased to 25%. The mechanical performance of Prototype 1 steel tempered at 580° C. was linked to the observed fracture surface morphology, which showed a ductile fracture surface with a comparably high plastic deformation due to necking at the gauge section.

Charpy impact tests were performed using an analog pendulum hammer (PW 30-E, Otto Wolpert-Werke) at room temperature following DIN EN ISO 148. According to the standard NADCA #207 2018, five Charpy impact specimens with dimensions were fabricated with a size of 10 mm×10 mm×55 mm. The Charpy impact energy was measured, and an acceptable Charpy impact energy of 10 Jcm⁻² was observed for Prototype 1 steel tempered at both the 560° C. and the 580° C. temperature. Particularly, the 580° C. tempered Prototype 1 steel exhibited a good combination of hardness and Charpy impact energy. Based on the mechanical properties obtained for the Prototype 1 steel, the NADCA tool steel requirements were still fulfilled with a hardness of 44 HRc at 590° C. and the superior Charpy impact energy compared to the conventional processed hot working tool steels.

The microstructural features of the Prototype 1 steel tempered at each temperature were also analysed, focusing on the carbide precipitation and the phase composition. EBSD mapping of the microstructure obtained after solutionizing at 1100° C. and oil quenching to RT. Due to the incomplete δ-ferrite to γ-austenite transformation during the latter heat treatment, angular δ-ferritic were detected in the quenched condition. The stable δ-ferrite content after solutionizing was caused by the low carbon content of 1.12 mol.-%. Hence, a multi-phase composition of δ-ferrite, α′-martensite and residual γ-austenite at the grain boundaries prevailed. A grain size in the range of between 2 μm and 8 μm with a normal distribution at 4 μm was calculated utilizing prior γ-austenite reconstruction, representing a fine grain size after solutionizing 1100° C. The non-indexed white grains confirmed again that a significant amount of δ-ferrite was stable at the solutionizing temperature.

The samples solutionized at 1100° C. and triple tempered at 580° C. were further investigated. Crystallographic information, e.g., crystal structure and the orientation relation between TiN inoculants and matrix, was obtained by calculating Fast Fourier Transform (FFT) patterns from high-resolution (HR) TEM bright-field images. Bright or dark spots in TEM BF images did not resemble atomic column positions. Nonetheless, crystal structure models for visualization of the crystal lattice were created using the CaRine Crystallography software package and overlayed to atomically resolved HRTEM images. Elemental analysis was conducted in scanning TEM mode either by spot analysis, line-scanning, or drift-corrected mapping using the EDS detector. For the quantification of elemental maps and line profiles, the build-in functions of GATAN GMS were utilized. High-angle annular dark-field (HAADF) images were recorded on an annular detector collecting scattered electrons from (76.5±2) mrad to (270±2) mrad polar collection angles. Thus, the contrast in HAADF images was proportional to the projected atomic number Z^{˜1.3} which allowed Z-contrast imaging. In the HAADF STEM images, carbides and nitrides were observed. The carbides were analyzed via STEM EDS point measurements and HRTEM FFT patterns to identify M₂C and Fe₃C carbides and TiVN nitride. In addition, two types of M₂C carbides were detected at this condition: rod-like M₂C with a hexagonal structure and spheriodized lamellar M₂C with an FCC structure. The remaining spheriodized Fe₃C with an orthorhombic structure indicated that the complete transformation from Fe₃C into M₂C was not entirely accomplished. However, overall, the precipitates detected corresponded closely to those predicted by the CALPHAD simulations of Prototype 1 steel.

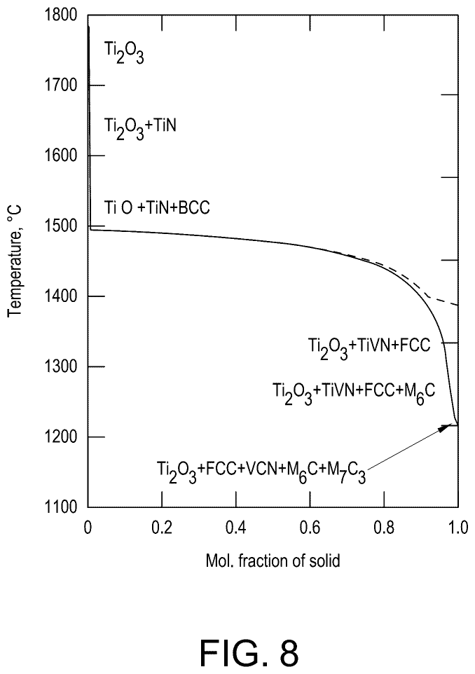

FIG. 9 is a graph showing the hardness vs. tempering temperature for the above noted compositions for different tempering temperatures. In particular, the hardness of Prototype 1 Steel, Prototype 2 steel, and conventional H10, H11, and H13 tool steel are presented for various tempering temperatures. As shown, Prototype 1 and Prototype 2 steel retained high hardness values, exhibiting hardness behavior comparable to other tool steels when tempered.

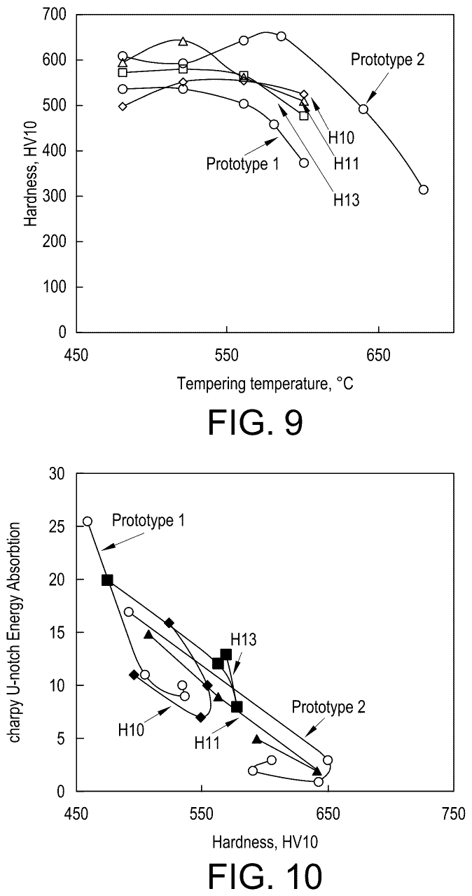

FIG. 10 is a graph of hardness versus energy absorption done with a Charpy U-notch test for the above noted compositions. As shown, Prototype 1 and Prototype 2 steel retained high Charpy energy absorption values, comparable to those of other tool steels.

Collectively, these results indicated that Prototype 1 steel alloy can be advantageous for printing and subsequent use as tool steel, and that the advantageous properties of Prototype 1 steel are related to the initial stabilization of δ-ferrite, improvements in grain morphology resulting from the use of TiN inoculants, and/or the incorporation of appropriate concentrations of carbide formers.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A metal alloy comprising:
iron;
carbon;
molybdenum;
vanadium;
chromium; and
tungsten, and wherein a ratio of a combined atomic percentage (at %) of molybdenum, vanadium, and tungsten relative to carbon within the metal alloy is between or equal to 2:1 and 5:1, and wherein an atomic percentage of the chromium is between or equal to 7 at % and 10 at %.

2. A metal alloy comprising:
iron;
carbon;
chromium; and
a transition metal selected from the group consisting of molybdenum, vanadium, and tungsten;
wherein a ratio of a combined atomic percentage (at %) of molybdenum, vanadium, and tungsten relative to carbon within the metal alloy is between or equal to 2:1 and 5:1,
wherein the metal alloy comprises one or more phases, the one or more phases including a first, δ-ferrite phase, and
wherein the first, δ-ferrite phase is present in the metal alloy in a phase fraction of at least 0.85.

3. The metal alloy of claim 2, wherein the metal alloy further comprises chromium, wherein an atomic percentage of the chromium is between or equal to 7 at % and 10 at %.

4. (canceled)

5. The metal alloy of claim 1, wherein an atomic percentage of carbon is between or equal to 0.5 at % and 2.5 at %.

6. The metal alloy of claim 1, wherein an atomic percentage of carbon is between or equal to 1.15 at % and 2.5 at %.

7. The metal alloy of claim 1, wherein the molybdenum, vanadium, and tungsten form M₂C precipitates within the metal alloy.

8. The metal alloy of claim 7, wherein the M₂C precipitates have a size that is between or equal to 1 nm and 10 nm.

9. The metal alloy of claim 1, wherein the metal alloy further comprises an inoculant.

10. An additive manufacturing method, the method comprising:
fusing one or more portions of a metal powder deposited during the additive manufacturing method to form a component, wherein the metal powder comprises particles comprising a metal alloy, wherein the metal alloy comprises:
iron;
carbon;
molybdenum;
vanadium;
chromium; and
tungsten, and wherein a ratio of a combined atomic percentage (at %) of molybdenum, vanadium, and tungsten relative to carbon within the metal alloy is between or equal to 2:1 and 5:1, and wherein an atomic percentage of the chromium is between or equal to 7 at % and 10 at %.

11. The metal alloy of claim 1, wherein the metal alloy comprises an austenitic phase and a ferritic phase, wherein the austenitic phase is less than or equal to 30% of the metal alloy.

12. The metal alloy of claim 11, wherein the ferritic phase is δ-ferrite.

13. The metal alloy of claim 12, wherein the δ-ferrite phase is present in the metal alloy in a phase fraction of at least 0.85.

14. The metal alloy of claim 1, wherein the metal alloy further comprises a grain refiner.

15. The metal alloy of claim 1, wherein the metal alloy comprises a nucleation catalyst.

16. The metal alloy of claim 12, wherein the δ-ferrite phase is present in the metal alloy in a phase fraction of at least 0.5.

17. The metal alloy of claim 16, wherein the δ-ferrite phase is present in the metal alloy in a phase fraction of at least 0.92.

18. An additive manufacturing method comprising fusing one or more portions of a metal powder deposited during the additive manufacturing method to form a component, wherein the formed component comprises the metal alloy of claim 1.

19. (canceled)

20. The metal alloy of claim 1, wherein molybdenum is present in a concentration between or equal to 2 at % and 4 at %.

21. (canceled)

22. The metal alloy of claim 1, wherein vanadium is present in a concentration between or equal to 0.5 at % and 2 at %.

23. (canceled)

24. The metal alloy of claim 1, wherein tungsten is present in a concentration between or equal to 0.1 at % and 0.3 at %.

25. The metal alloy of claim 2, wherein the one or more phases include a second, austenitic phase.

26. The metal alloy of claim 2, wherein the first, δ-ferrite phase is present in the metal alloy in a phase fraction of at least 0.9.

27. The metal alloy of claim 26, wherein the first, δ-ferrite phase is present in the metal alloy in a phase fraction of at least 0.92.
